(19) United States
(12) Patent Application Publication
(10) Pub. No.: US 2004/0222154 A1
(43) Pub. Date: Nov. 11, 2004

(54) Treatment of non-aqueous aldehyde waste streams

(75) Inventors: Joseph V. Kurian, Hockessin, DE (US); Yuanfeng Liang, Chadds Ford, PA (US)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(73) Assignee: E.I.du Pont de Nemours & Company

(21) Appl. No.: 10/434,038

(22) Filed: May 8, 2003

(51) Int. Cl. B01D 11/00

(52) U.S. Cl. 210/634; 210/739

(57) ABSTRACT

This invention relates to an improved process for rendering non-aqueous waste streams that contain aldehydes and ketones, in particular, alpha, beta-ethylenically unsaturated aldehydes and ketones, non-toxic to biological treatment systems by contacting the waste streams with organic monoamines, organic polyamines and/or ammonium compounds at essentially ambient conditions.

### FIELD OF THE INVENTION

This invention concerns a process for the treatment of non-aqueous waste streams containing aldehyde(s) and ketone(s), in particular, alpha, beta-ethylenically unsaturated aldehydes comprising contacting said streams with organic monoamines, organic polyamines including diamines, triamines and tetramines, and/or inorganic ammonium compounds.

### TECHNICAL BACKGROUND OF THE INVENTION

The toxicity of aldehydes and ketones, especially alpha, beta-ethylenically unsaturated aldehydes and ketones, to biological waste treatment systems, even in low concentrations, has been recognized by those skilled in the art. A review article on this problem is presented by V. T. Stack, Jr. in Industrial and Engineering Chemistry, Volume 49, No. 5, page 913 (1957). Stack reports that of these compounds, acrolein has the most toxic effect on biological waste treatment processes. Waste streams containing alpha, beta-ethylenically unsaturated aldehydes and ketones must be treated to reduce the concentration of these substances to very low levels before the waste stream is further treated by a biological system. Failure to adequately pre-treat the waste streams can result in the biomass either being killed, or at least inhibited to a very low level of activity.

Treatment of aqueous waste streams containing alpha, beta-ethylenically unsaturated aldehydes and ketones is known in the art. U.S. Pat. No. 3,923,648 discloses a method for rendering alpha, beta-ethylenically unsaturated aldehydes and/or ketones that are contained in wastewaters non-toxic to biological treatment systems. This method involves contacting the wastewaters with sufficient base to render the pH of the wastewaters alkaline, maintaining the alkaline wastewaters at a temperature of about 25° C. to 100° C. for at least about 15 minutes, and then degrading the wastewater in a biological system containing an active biomass process. The base disclosed as being preferred is an alkali metal hydroxide, but the use of other bases, such as soluble organic amines, e.g., methylamine, ethylamine, dimethylamine, triethylamine, and the like, and alkanolamines including monoalkanolamines, dialkanolamines, trialkanolamines, N-monoalkylmonoalkanolamines, and N,N′-dialkylalkanolamines and the like, are also disclosed.

U.S. Pat. No. 5,459,229 discloses a process for the preparation of a 1,3-propanediol based polyester in which an aqueous acrolein-containing waste stream is treated with a sufficient quantity of base to increase the pH to above 7.5 for a time effective to lower the acrolein content, followed, optionally, by dilution and biotreatment. The base utilized is preferably an inorganic base, most preferably sodium hydroxide.

U.S. Pat. Nos. 6,277,289 and 6,325,945 disclose a process for reducing the levels of alpha, beta-ethylenically unsaturated aldehydes and ketones in aqueous wastewater streams.

One objective of the present invention is to provide a more efficient and effective process for reducing the levels of alpha, beta-ethylenically unsaturated aldehydes and ketones in non-aqueous waste streams.

### SUMMARY OF THE INVENTION

The present invention provides a process for reducing the concentration of aldehydes and ketones, especially alpha, beta-ethylenically unsaturated aldehydes and ketones, and most especially acrolein, in non-aqueous waste streams, particularly in non-aqueous waste streams resulting from the manufacture of 1,3-propanediol and polyesters and polyols derived therefrom, said process comprising:

(a) contacting a non-aqueous waste stream comprising at least one aldehyde and/or at least one ketone with an effective amount of nitrogen-containing base compounds; and

(b) maintaining said waste stream in contact with the nitrogen-containing base compounds for a sufficient length of time to allow at least a 50% reduction in aldehyde and/or ketone concentration.

### DETAILED DESCRIPTION OF THE INVENTION

This invention relates to a process for treating non-aqueous waste streams with selected nitrogen-containing base compounds in order to reduce the concentration of aldehydes and/or ketones that are contained therein by at least 50%, and more particularly to decrease the concentration of those alpha, beta-ethylenically unsaturated aldehydes and/or ketones that are toxic to biological waste treatment systems.

The term “non-aqueous waste stream” as used herein means the waste streams treated in accordance with the process of this invention may contain up to 10 wt. % dissolved water, more preferably up to 2 wt. % dissolved water, and most preferably up to 1 wt. % dissolved water.

The term “non-aqueous solution” as used herein means the solution may contain up to 10 wt. % dissolved water, more preferably up to 2 wt. % dissolved water, and most preferably up to 1 wt. % dissolved water

The term “essentially ambient conditions” as used herein means the process of the invention is applied to a non-aqueous waste stream at the existing waste stream temperature, which generally ranges from about 0° C. to 65° C.

In the process according to the invention, a non-aqueous waste stream that contains at least one aldehyde and/or ketone is contacted with an effective amount of nitrogen-containing base compound, and maintained in contact with the effective amount of nitrogen-containing base compound for a period of time that is long enough to allow a 50% reduction in the aldehyde and/or ketone concentration.

The at least one aldehyde and/or ketone of particular interest in the process of the present invention include, but are not limited to, alpha, beta-ethylenically unsaturated aldehydes and ketones, such as acrolein, methacrolein (methacrylaldehyde), crotonaldehyde, 2,4-hexadienal, acetaldehyde, methyl vinyl ketone, and mixtures thereof.

The preferred nitrogen-containing base compounds include, but are not limited to, organic monoamines, such as methylamine, ethylamine, dimethylamine, and mixtures thereof, and organic polyamines, defined herein as organic amines comprising at least two amines, preferably diamines, such as hexamethylenediamine, 2-methyl pentamethylene-diamine, 2-methyl hexamethylene diamine, 3-methyl hexamethylene diamine, 2,5-dimethyl hexamethylene diamine, 2,2-dimethylpentamethylene diamine, 5-methylnonane diamine, dodecamethylene diamine, 2,2,4- and 2,4,4-trimethyl hexamethylene diamines, 2,2,7,7-tetramethyl octamethylene diamine, meta-xylylidene diamine, paraxylylidene diamine, diaminodicyclohexyl methane, C₂-C₁₆ aliphatic diamines, which may be substituted with at least one alkyl group, N-alkyl and NN′-dialkyl derivatives thereof, and mixtures thereof. The most preferred diamine is hexamethylenediamine. Other organic polyamines that are also useful in the present invention include, but are not limited to, triamines, such as bis(hexamethylene triamine), tetramines, other polyamines, and mixtures thereof.

Another preferred nitrogen-containing base compound is inorganic ammonium salt, e.g., ammonium carbonate. The preferential use of inorganic ammonium salts is generally favored when the solvent contains small amounts of dissolved water to promote solubility.

An “effective amount” of nitrogen-containing base compound means that enough nitrogen-containing base compound is added to the non-aqueous waste stream so as to produce at least a 50% reduction in the aldehyde and/or ketone concentration contained therein. For example, when organic polyamines are added to the non-aqueous waste stream so as to effectuate the desired 50% reduction in aldehyde and/or ketone concentration, the “effective amount” of organic polyamine that is added to the non-aqueous waste stream is the amount that produces an organic polyamine concentration in the non-aqueous waste stream ranging from about 0.02 to about 20 wt. %, more preferably from about 0.04 to 15 wt %, and most preferably from about 0.05 to about 10 wt %. A person of ordinary skill in the art would know how to determine, by using, for example, Gas Chromotography (GC), the quantity of nitrogen-containing base compound that has to be added to the aldehyde and/or ketone containing non-aqueous waste stream to be an “effective amount”.

Although the non-aqueous waste stream is generally maintained in contact with the nitrogen-containing base compound for a period of time that is long enough to allow a 50% reduction in the aldehyde and/or ketone concentration, the amount of time generally ranges from about 5 minutes to about 3 hours, more preferably from about 20 minutes to about 2 & ½ hours, and most preferably from about 30 minutes to about 2 hours.

The temperature utilized in treating non-aqueous waste streams is not critical. The application of this process to an industrial waste stream, therefore, generally takes place at essentially ambient conditions.

The process of the present invention is especially useful for treating non-aqueous waste streams containing acrolein resulting from the manufacture of 1,3-propanediol and polyesters and polyols derived therefrom, e.g., poly(trimethylene naphthalate). Of these, the process of the present invention is preferably used to treat non-aqueous waste streams resulting from the manufacture of 1,3-propanediol based polyesters, and more specifically to non-aqueous waste streams resulting from the manufacture of poly(trimethylene terephthalate) (3GT).

The present invention also relates to a process for making polyesters or polyols that involves using an effective amount of nitrogen-containing base compounds to remove at least 50% of the at least one aldehyde and/or at least one ketone contained in the non-aqueous waste stream formed when polyesters or polyols are made.

The polyesters made in accordance with the process of the present invention include, but are not limited to, poly(trimethylene terephthalate) polymers, poly(trimethylene naphthalate) polymers, poly(trimethylene isophthalate) polymers, copolymers thereof, and mixtures thereof.

The polyols made in accordance with the present invention include, but are not limited to, poly(trimethylene glycol), copolymers thereof, and mixtures thereof.

In making, for example, 3GT polyester resins by reacting 1,3-propanediol with either terephthalic acid, or a lower dialkyl ester of terephthalic acid at an elevated temperature, by-products are formed that are contained in the non-aqueous solution of the distillate. These by-products are comprised primarily of acrolein and allyl alcohol, and although the amount of the by-products contained in the distillate is already low, it is desired that this amount be further reduced, especially when 3GT polyesters are prepared from a lower dialkyl ester of terephthalic acid and excess 1,3-propanediol. For example, when the dialkyl ester of terephthalic acid and excess 1,3-propanediol are reacted to produce the 3GT polymer, a non-aqueous waste stream containing an alkyl alcohol, such as methanol, excess 1,3-propanediol, and alpha, beta-ethylenically unsaturated aldehydes and/or ketones, such as acrolein, is formed. More specifically, when dimethyl terephthalate is reacted with excess 1,3-propanediol in order to form the 3GT polymer, a non-aqueous waste stream comprising methanol, excess 1,3-propanediol, and alpha, beta-ethylenically unsaturated aldehydes and/or ketones, such as acrolein, is formed. As the non-aqueous waste streams that result from the manufacture of 1,3-propanediol based polyesters and polyols are well-known to those skilled in the art, a person of ordinary skill in the art is familiar with the available processes for producing polyesters and polyols that result in non-aqueous waste streams containing at least one aldehyde and/or at least one ketone that can be treated in accordance with the process of the present invention.

The at least one aldehyde and/or at least one ketone removed by at least 50% from the resulting non-aqueous waste stream formed when a polyester or polyol is made, is as described hereinabove.

The nitrogen-containing base compounds used in removing at least 50% of the at least one aldehyde and/or at least one ketone contained in the non-aqueous waste stream formed when the polyesters or polyols are made, are as described hereinabove.

The “effective amount” of nitrogen-containing base compound that is needed to remove at least 50% of the at least one aldehyde and/or at least one ketone from the resulting non-aqueous waste stream that is formed when a polyester or polyol is produced, is as described hereinabove.

The temperature utilized in treating the non-aqueous waste stream is not critical. The application of this process to an industrial waste stream, therefore, generally takes place at essentially ambient conditions.

### EXPERIMENTAL

### EXAMPLE 1

### Treatment of a Methanol Solution Containing acrolein With hexamethylenediamine (HMD)

A methanol control solution having less than 0.1 wt % water and containing acrolein (˜4,000 ppm) was prepared and divided into 3 sample portions. Hexamethylenediamine (HMD) solution in methanol was added to two of the sample portions so as to produce two samples containing 0.5 wt % and 1.0 wt % HMD (HMD/acrolein mol ratios of 0.6 and 1.1, respectively). Analysis by gas chromatography with solid phase micro-extraction was performed 2 hours after the samples were prepared to quantify the acrolein levels in each of the three samples. The control sample was found to contain 4300 ppm acrolein. No acrolein could be detected in the samples to which HMD was added.

### EXAMPLE 2

### Treatment of an ethylene glycol Solution Containing acrolein With hexamethylenediamine (HMD)

An ethylene glycol control solution having less than 0.1 wt % water and containing acrolein was prepared and divided into 3 sample portions. HMD solution in ethylene glycol was added to two of the sample portions so as to produce two samples containing 0.46 wt % and 0.8 wt % HMD (HMD/acrolein mol ratios of 0.79 and 1.38, respectively). Gas chromatographic analysis was performed 1 hour after the samples were prepared to quantify the acrolein levels in each of the three samples. The control sample was found to contain 2,800 ppm acrolein. No acrolein could be detected in the samples to which HMD was added.

### EXAMPLE 3

### Treatment of a 1,3-propanediol Solution Containing acrolein With hexamethylenediamine (HMD)

A 1,3-propanediol control solution having less than 0.1 wt % water and containing acrolein was prepared and divided into 3 sample portions. HMD solution in 1,3-propanediol was added to two of the sample portions so as to produce two samples containing 0.46 wt % and 0.8 wt % HMD (HMD/acrolein mol ratios of 0.85 and 1.48, respectively). Gas chromatographic analysis was performed 1 hour after the samples were prepared to quantify the acrolein levels in each of the three samples. The control sample was found to contain 2,600 ppm acrolein. No acrolein could be detected in the samples to which HMD was added.

### EXAMPLE 4

### Treatment of a 1,4-butanediol Solution Containing acrolein With hexamethylenediamine (HMD)

A 1,4-butanediol control solution having less than 0.1 wt % water and containing acrolein was prepared and divided into 3 sample portions. HMD solution in 1,4-butanediol was added to two of the sample portions so as to produce two samples containing 0.46 wt % and 0.8 wt % HMD (HMD/acrolein mol ratios of 1.22 and 2.1, respectively). Gas chromatographic analysis was performed 1 hour after the samples were prepared to quantify the acrolein levels in each of the three samples. The control sample was found to contain 1,810 ppm acrolein. No acrolein could be detected in the samples to which HMD was added.

We claim:

1. A process for reducing aldehyde and/or ketone concentration in a non-aqueous waste stream, said process comprising
(a) contacting a non-aqueous waste stream comprising at least one aldehyde and/or at least one ketone with an effective amount of nitrogen-containing base compounds; and
(b) maintaining said waste stream in contact with the nitrogen-containing base compounds for a sufficient length of time to allow at least a 50% reduction in aldehyde and/or ketone concentration.

2. The process of claim 1, wherein the waste stream is contacted with the nitrogen-containing base compounds at essentially ambient conditions.

3. The process of claim 2, wherein the non-aqueous waste stream comprises at least one aldehyde and/or at least one ketone selected from at least one of alpha, beta-ethylenically unsaturated aldehydes, alpha, beta-ethylenically unsaturated ketones, and mixtures thereof.

4. The process of claim 3, wherein the at least one aldehyde and/or at least one ketone are selected from at least one of acrolein, methacrolein (methacrylaldehyde), crotonaldehyde, 2,4-hexadienal, acetaldehyde, methyl vinyl ketone, and mixtures thereof.

5. The process of claim 4, wherein the non-aqueous waste stream comprises acrolein.

6. The process of claim 4, wherein the nitrogen-containing base compounds are selected from at least one of organic monoamines, organic polyamines, inorganic ammonium compounds, and mixtures thereof.

7. The process of claim 6, wherein the organic monoamines are selected from at least one of methylamine, ethylamine, dimethylamine, and mixtures thereof.

8. The process of claim 6, wherein the organic polyamines are selected from at least one of organic diamines, organic triamines, organic tetramines, and mixtures thereof.

9. The process of claim 8, wherein the organic polyamines are selected from at least one of hexamethylenediamine, 2-methyl pentamethylene diamine, 2-methyl hexamethylene diamine, 3-methyl hexamethylene diamine, 2,5-dimethyl hexamethylene diamine, 2,2-dimethylpentamethylene diamine, 5-methylnonane diamine, dodecamethylene diamine, 2,2,4- and 2,4,4-treimethyl hexamethylene diamine, 2,2,7,7-tetramethyl octamethylene diamine, meta-xylylidene diamine, paraxylidene diamine, diaminodicyclohexyl methane, C₂-C₁₆ aliphatic diamines optionally substituted with at least one alkyl group, N-alkyl and N,N′-dialkyl derivatives thereof, and mixtures thereof.

10. The process of claim 9, wherein the organic polyamines are hexamethylenediamines.

11. The process of claim 8, wherein the non-aqueous waste stream comprises about 0.05 to about 10 wt. % of the organic polyamines.

12. A process for making a polyester or a polyol, comprising
(a) preparing a polyester or a polyol;
(b) forming a non-aqueous waste stream comprising at least one aldehyde and/or at least one ketone; and
(c) treating the non-aqueous waste stream with an effective amount of nitrogen-containing base compounds to remove at least 50% of the at least one aldehyde and/or at least one ketone from the non-aqueous waste stream.

13. The process of claim 12, wherein the polyester is selected from at least one of poly(trimethylene terephthalate) polymers, poly(trimethylene naphthalate) polymers, poly(trimethylene isophthalate) polymers, copolymers thereof, and mixtures thereof.

14. The process of claim 13, wherein the nitrogen-containing base compounds are selected from at least one of organic monoamines, organic polyamines, inorganic ammonium compounds, and mixtures thereof.

15. The process of claim 14, wherein the organic monoamines are selected from at least one of methylamine, ethylamine, dimethylamine, and mixtures thereof.

16. The process of claim 14, wherein the organic polyamines are selected from at least one of organic diamines, organic triamines, organic tetramines, and mixtures thereof.

17. The process of claim 16, wherein the non-aqueous waste stream comprises acrolein.

18. The process of claim 17, wherein the non-aqueous waste stream comprises about 0.05 wt. % of the organic polyamines.

19. The process of claim 18, wherein the non-aqueous waste stream comprises up to about 10 wt. % of the organic polyamines.

20. The process of claim 17, wherein the organic polyamines are selected from at least one of hexamethylenediamine, 2-methyl pentamethylene diamine, 2-methyl hexamethylene diamine, 3-methyl hexamethylene diamine, 2,5-dimethyl hexamethylene diamine, 2,2-dimethylpentamethylene diamine, 5-methylnonane diamine, dodecamethylene diamine, 2,2,4-and 2,4,4-treimethyl hexamethylene diamine, 2,2,7,7-tetramethyl octamethylene diamine, meta-xylylidene diamine, paraxylidene diamine, diaminodicyclohexyl methane, C₂-C₁₆ aliphaticdiamines optionally substituted with one or more alkyl groups, N-alkyl and N,N′-dialkyl derivatives thereof, and mixtures thereof.

21. The process of claim 20, wherein the organic polyamines are hexamethylenediamines.

22. The process of claim 17, wherein the non-aqueous waste stream is treated with the nitrogen-containing base compounds at a temperature ranging from about 0° C. to about 65° C.

23. The process of claim 14, wherein the inorganic ammonium compound is ammonium carbonate.
